(19) United States
(12) Patent Application Publication
(10) Pub. No.: US 2026/0280435 A1
(43) Pub. Date: Sep. 17, 2026

(54) FULL-BRIDGE LLC CONVERTER USING PHASE-SHIFT METHOD

(71) Applicant: Murata Manufacturing Co., Ltd., Nagaokakyo-shi (JP)

(72) Inventor: Jin Mun BAE, Milton Keynes (GB)

(21) Appl. No.: 19/564,661

(22) Filed: Mar. 12, 2026

Related U.S. Application Data
(60) Provisional application No. 63/771,158, filed on Mar. 13, 2025.

(51) Int. Cl. H02M 3/335; H02M 1/00; H02M 3/00

(52) U.S. Cl. CPC H02M 3/33573; H02M 1/0043; H02M 3/01

(57) ABSTRACT

A full-bridge LLC converter includes a transformer including a primary winding and a secondary winding and includes a primary stage connected to the primary winding. The primary stage includes a power module integrated circuit (IC) and a regenerative circuit that is connected to the first and the second switching output terminals and the input-switching-current terminal to provide a regenerative current to the power switches. The power module IC includes a first switching output terminal connected to a first end of the primary winding, a second switching output terminal connected to a second end of the primary winding opposite to the first end of the primary winding, power switches connected to the first and the second switching output terminals within the power module IC, and an input-switching-current terminal that receives an input switching current that is provided to the power switches.

### CROSS REFERENCE TO RELATED APPLICATIONS

This application claims the benefit of U.S. Patent Application No. 63/771,158 filed on Mar. 13, 2025. The entire contents of this application are hereby incorporated by reference.

### BACKGROUND OF THE INVENTION

### 1. Field of the Invention

The present invention relates to converters. More specifically, the present invention relates to methods of efficiently driving converters.

### 2. Description of the Related Art

Known phase-shift, full-bridge converters can achieve high conversion efficiency and excellent control characteristics because the known phase-shift, full-bridge converters can implement soft switching, including zero-voltage switching ZVS. However, the circuit configuration of known phase-shift, full-bridge converters is complex, and the cost is high, making it difficult to use as small-capacity power supplies. Also, semiconductor manufacturers have dedicated control integrated circuits (ICs) (including, for example, control ICs UC2875 and UCC2895 by Texas Instruments), but these dedicated control ICs are expensive. Furthermore, known phase-shift, full-bridge converters include many difficult elements for use in open-loop control. Only a few known LLC converters use the phase-shift, full-bridge topology. FIG. 1 shows the circuit diagram of a known phase-shift, full-bridge control IC that implements control of a bridge power stage by phase-shifting the switching of one half-bridge with respect to another half-bridge, allowing constant frequency pulse-width modulation in combination with resonant, zero-voltage switching for high efficiency performance at high frequencies. But this known control IC is expensive and complicated to implement.

Known analog high-speed comparator ICs can be less expensive, but such known analog high-speed comparator ICs typically have long propagation delay times, making it not possible to generate two 1-MHz square waves with a phase difference of 180°. Analog high-speed comparator ICs with shorter propagation delay times are known but are more expensive.

### SUMMARY OF THE INVENTION

To overcome the problems described above, example embodiments of the present invention provide phase-shift, full-bridge LLC converters each with a very simple structure. A comparator IC, such as, for example, a high-speed analog comparator IC, can be used to generate a basic square wave, and another phase-shift side creates a phase shift using a propagation delay time of the comparator IC, which is typically considered a drawback of the comparator IC. High-speed analog comparator ICs have a low cost. The LLC converter is implemented by driving a transformer using a low-cost gate driver IC or power module IC as a power block with the two generated phase signals. In addition, by adding a regenerative circuit between the power module IC and the transformer, the conversion efficiency can be improved by over 5%, for example.

According to an example embodiment of the present invention, a full-bridge LLC converter includes a transformer including a primary winding and a secondary winding and includes a primary stage connected to the primary winding. The primary stage includes a power module integrated circuit (IC) and a regenerative circuit that is connected to the first and the second switching output terminals and the input-switching-current terminal to provide a regenerative current to the power switches. The power module IC includes a first switching output terminal connected to a first end of the primary winding, a second switching output terminal connected to a second end of the primary winding opposite to the first end of the primary winding, power switches connected to the first and the second switching output terminals within the power module IC, and an input-switching-current terminal that receives an input switching current that is provided to the power switches.

The regenerative circuit can include a first diode connected between the first switching output terminal and the input-switching-current terminal and a second diode connected between the second switching output terminal and the input-switching-current terminal. The first diode can include a first Schottky barrier diode, and/or the second diode can include a second Schottky barrier diode.

The full-bridge LLC converter can further include an additional power module integrated circuit (IC) that is in the primary stage and that includes additional power switches and an additional regenerative circuit that is connected to the additional power module IC and that provides an additional regenerative current to the additional power switches.

The full-bridge LLC converter can further include a secondary stage that is connected to the secondary winding and that includes a voltage-doubling rectifier circuit.

According to an example embodiment of the present invention, a signal generator includes a first comparator integrated circuit (IC) that provides a first square wave and a second comparator integrated circuit (IC) that receives the first square wave at an input terminal of the second comparator IC and that provides a second square wave that is phase shifted with respect to the first square wave by a propagation delay time of the second comparator IC.

The input terminal can be a positive terminal of the second comparator IC or can be a negative terminal of the second comparator IC. The first and/or the second comparator IC can include an analog comparator IC. Alternatively, the first and/or the second comparator IC can include a high-speed analog comparator IC.

According to an example embodiment of the present invention, a converter includes the signal generator of one of the various example embodiments of the present invention, a transformer including a primary winding and a secondary winding, and a primary stage including a switching circuit that includes power switches connected to the primary winding, that receives the first and the second square waves from the signal generator, and that turns on and off the power switches based on the first and the second square waves to control current in the primary winding.

The switching circuit can include a full-bridge power module integrated circuit (IC) that includes the power switches. The converter can further include a regenerative circuit that is connected to the full-bridge power module IC and that provides a regenerative current to the power switches. The full-bridge power module IC can include a first switching output terminal connected to a first end of the primary winding, a second switching output terminal connected to a second end of the primary winding opposite to the first end of the primary winding, and an input-switching-current terminal that receives an input switching current that is provided to the power switches, the power switches can be connected to the first and the second switching output terminals within the full-bridge power module IC, and the regenerative circuit can be connected to the first and the second switching output terminals and the input-switching-current terminal to provide the regenerative current to the power switches.

The switching circuit can include an additional full-bridge power module integrated circuit (IC). The switching circuit can include two separate half-bridge converters that are connected to define a full-bridge converter. The converter can further include a secondary stage that is connected to the secondary winding and that includes a voltage-doubling rectifier circuit.

The above and other features, elements, characteristics, steps, and advantages of the present invention will become more apparent from the following detailed description of example embodiments of the present invention with reference to the attached drawings.

### BRIEF DESCRIPTION OF THE DRAWINGS

FIG. 1 is a circuit diagram of a known phase-shift resonant integrated circuit controller.

FIG. 2 is a circuit diagram of a signal generator using the positive input of an comparator IC.

FIG. 3 is a circuit diagram of a signal generator using the negative input of an comparator IC.

FIG. 4 shows waveforms of the signal generator of FIG. 2.

FIG. 5 show waveforms of the signal generator of FIG. 3.

FIG. 6 is a circuit diagram of a phase-shift, full bridge LLC converter that can be used with the signal generators of FIGS. 2 and 3.

FIGS. 7 and 8 show waveforms of the phase-shift, full bridge LLC converter of FIG. 6.

FIG. 9 is a circuit diagram of a phase-shift, full bridge LLC converter with a regenerative circuit.

FIG. 10 shows waveforms of the phase-shift, full bridge LLC converter of FIG. 9 with the regenerative circuit.

FIG. 11 shows waveforms of the phase-shift, full bridge LLC converter of FIG. 9 without the regenerative circuit.

FIG. 12 is a circuit diagram of a phase-shift, full bridge LLC converter including two half-bridge modules.

FIG. 13 is a circuit diagram of a two-phase, phase-shift, full bridge LLC converter.

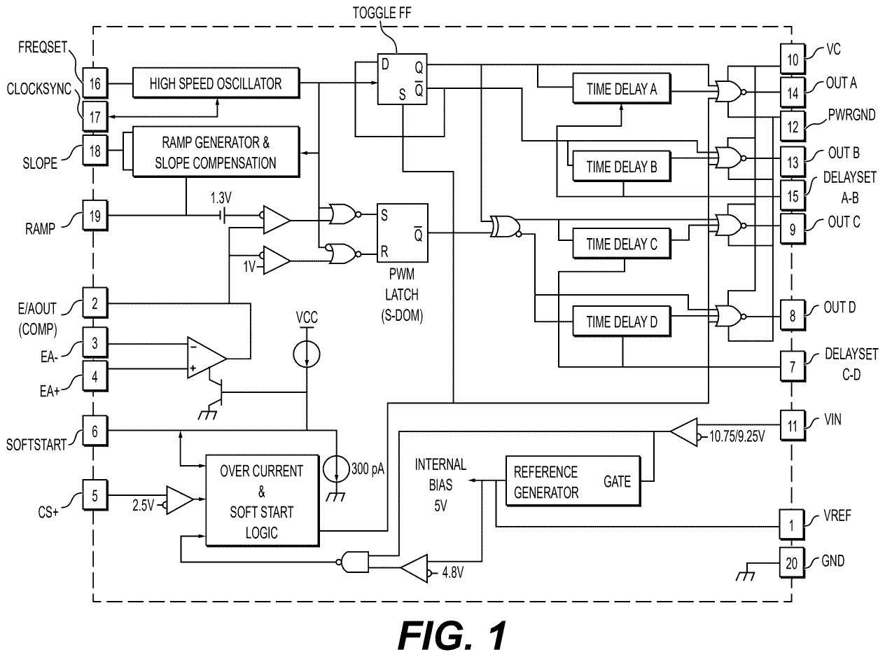

### DETAILED DESCRIPTION OF EXAMPLE EMBODIMENTS

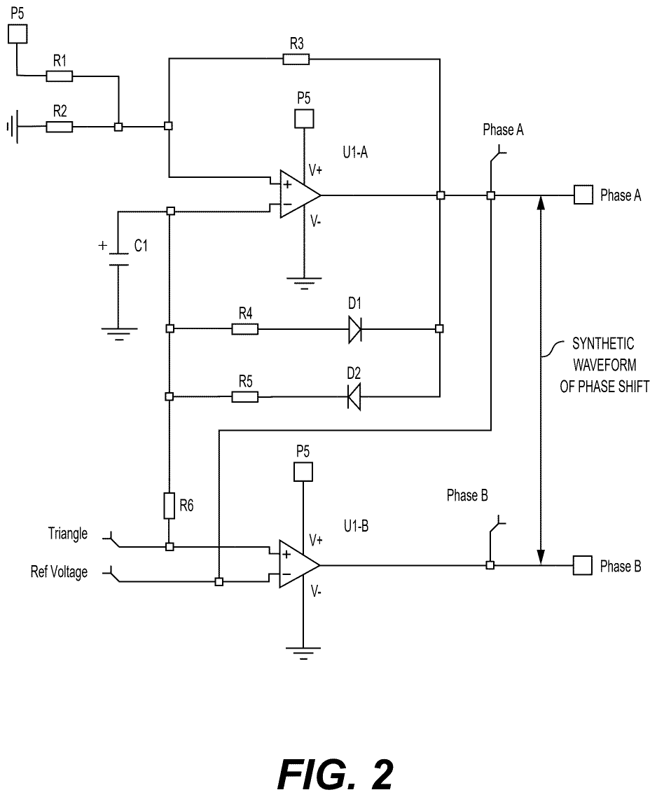

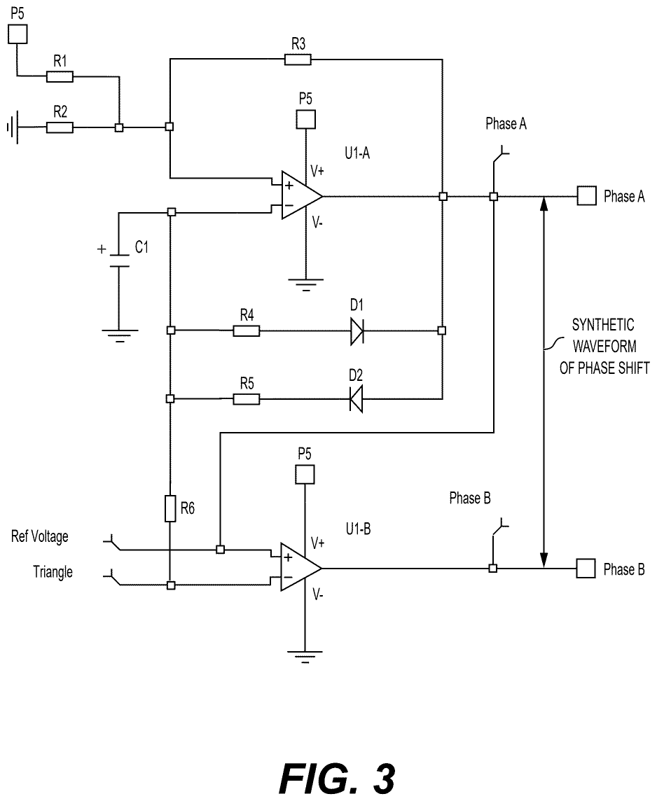

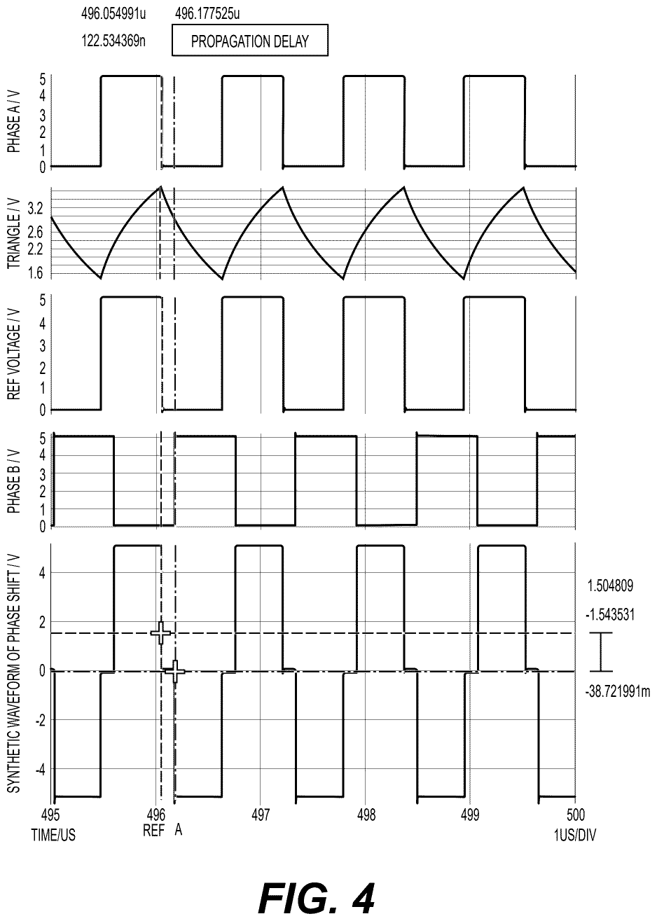

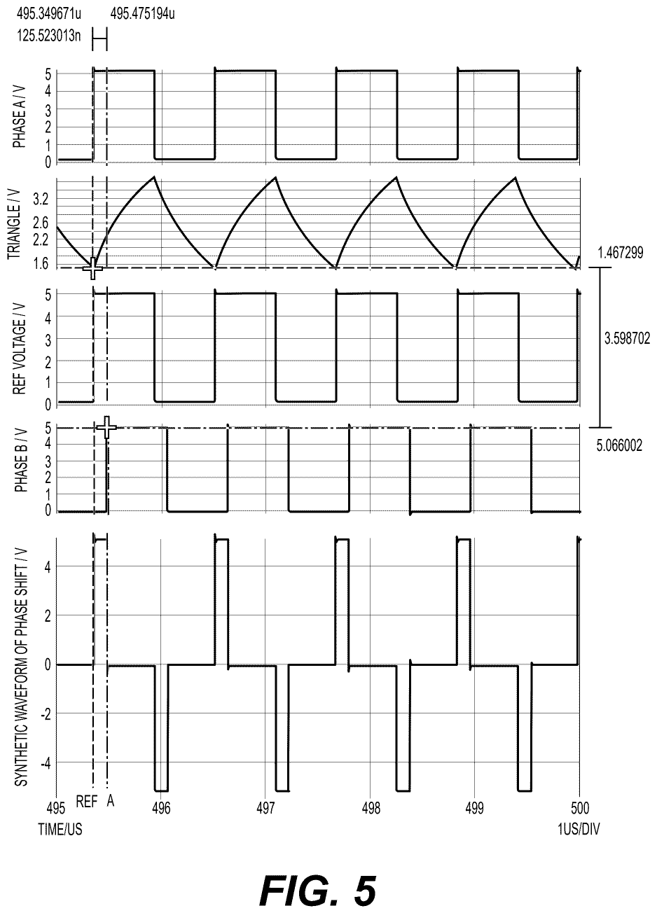

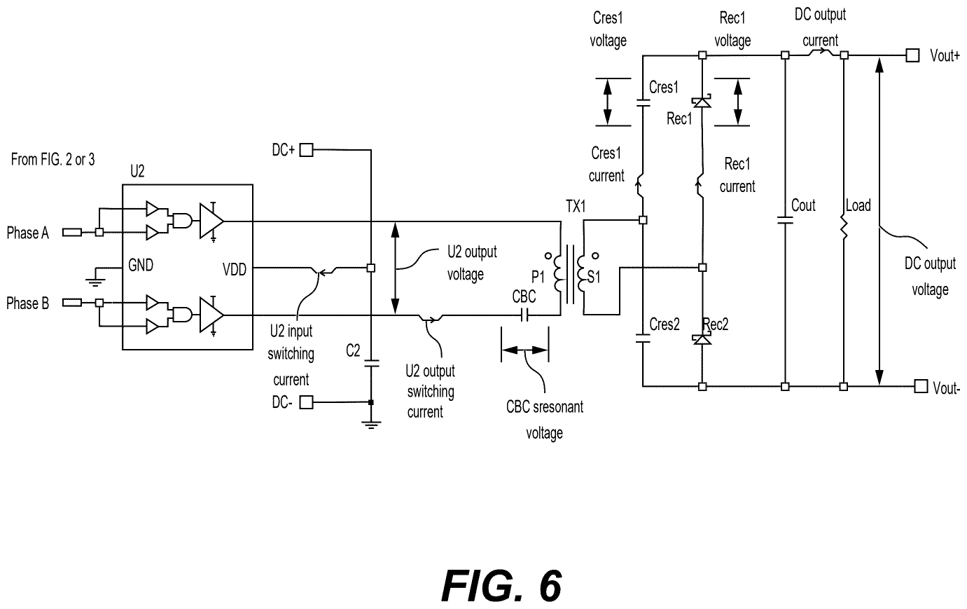

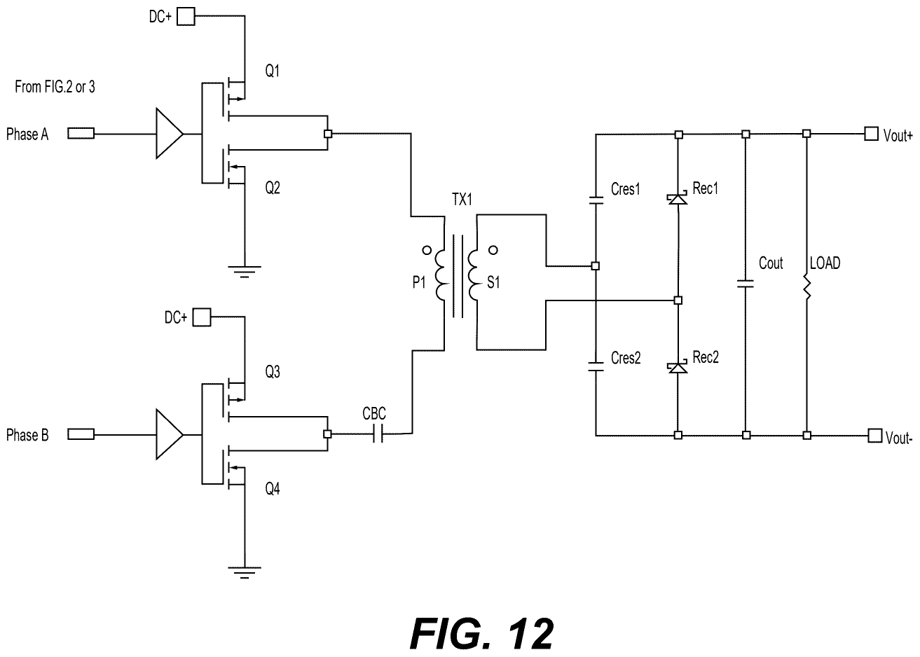

FIGS. 2 and 3 show circuit diagrams of signal generators that use comparator ICs U1-A and U1-B to generate signals as shown in FIGS. 4 and 5 that can be provided to the full-bridge power module ICs U2 and U3 in FIGS. 6, 9, and 13 or the switches Q1, Q2, Q3, Q4 in FIG. 12. The second square wave Phase B of the comparator IC U1-B is generated based on the first square wave Phase A of the comparator IC U1-A and is phase shifted with respect to the first square wave Phase A by the propagation delay of the comparator IC U1-B.

In FIGS. 2 and 3, the comparator IC U1-A is used to generate a first square wave Phase A that is used as an input for the comparator IC U1-B. As shown in FIG. 4, the first square wave Phase A is used as the reference voltage in FIGS. 2 and 3 that is applied to the comparator IC U1-B. In FIG. 2, the first square wave Phase A is applied to the positive input of the comparator IC U1-B and the reference voltage is applied to the negative input of the comparator IC U1-B, and in FIG. 3, the first square wave Phase A is applied to the negative input of the comparator IC U1-B and the reference voltage is applied to the positive input of the comparator IC U1-B. As shown in FIG. 5, the synthetic waveform, which is the signal across the output terminals, is generated as the difference between the first square wave Phase A and the second square wave Phase B.

The terminal P5 is connected via resistors R1, R2 to the positive terminal of the comparator U1-A. The terminal P5 is connected to the positive power pin V+ of the comparator U1-A, and the negative power pin V− of the comparator U1-A is connected to ground. The resistor R3 is connected between the positive input terminal of the comparator U1-A and the output of the comparator U1-A. The capacitor C1 is connected to the negative terminal of the comparator U1-A. The signal TRIANGLE is connected to a node between the capacitor C1 and the negative terminal of the comparator U1-A. The resistor R4 and the diode D1 are connected in series between the output of the comparator U1-A and the node between the capacitor C1 and the negative terminal of the comparator U1-A. The anode of the diode D1 is connected to the resistor R4, and the cathode of the diode D1 is connected to the output of the comparator U1-A. The resistor R5 and the diode D2 are connected in series between the output of the comparator U1-A and the node between the capacitor C1 and the negative terminal of the comparator U1-A. The cathode of the diode D2 is connected to the resistor R5, and the anode of the diode D2 is connected to the output of the comparator U1-A.

In FIG. 2, the signal TRIANGLE is connected to the positive terminal of the comparator U1-B, and the output Phase A of the comparator U1-A is connected to the negative output terminal of the comparator U1-B. And in FIG. 3, the signal TRIANGLE is connected to the negative terminal of the comparator U1-B, and the output Phase A of the comparator U1-A is connected to the positive output terminal of the comparator U1-B. The terminal P5 is connected to the positive power pin V+ of the comparator U1-B, and the negative power pin V− of the comparator U1-B is connected to ground.

The synthetic wave shown in FIG. 4 is generated across the output terminals of the signal generator of FIG. 2.

The comparator ICs U1-A, U1-B can each be an analog comparator IC, including, for example, a high-speed analog comparator IC, and can be selected based on the propagation delay of the integrated circuit, which determines the phase shift between the first square wave Phase A and the second square wave Phase B and determines the pulse width of the synthetic waveform. The comparator IC can be chosen with a delay suitable for the target switching frequency. High-speed with respect to the comparator IC can mean that the comparator IC has a propagation delay sufficiently short, relative to the desired switching period, to generate the desired phase-shifted waveform. In some example embodiments, the comparator IC can be suitable for operation at a switching frequency of, for example, about 100 kHz to about 2 MHz, within manufacturing and/or measurement tolerances, and can have a propagation delay of, for example, less than about 250 ns, for example, about 123 ns, within manufacturing and/or measurement tolerances.

The terminal P5 is the positive supply terminal. The resistors R1, R2 are connected between the terminal P5 and the positive input of the comparator IC U1-A to establish the input bias/reference level of the comparator IC U1-A. The resistor R3 is connected between the output and the positive input of the comparator IC U1-A, contributing to the threshold setting and the hysteresis/positive feedback of the comparator IC U1-A. The capacitor C1, resistors R4-R6, diodes D1, D2, and the signal TRIANGLE define a circuit that provides comparison signals to the comparator ICs U1-A, U1-B. In FIG. 2, a first comparison signal is provided to the negative input of the comparator IC U1-A, and a second comparison signal is provided to the positive input of the comparator IC U1-B. And in FIG. 3, the first comparison signal is provided to the negative input of the comparator IC U1-A, and the second comparison signal is provided to the negative input of the comparator IC U1-B. The capacitor C1 is connected to the negative input of the comparator IC U1-A and, together with the signal TRIANGLE, forms the comparison/input node. The resistor R6 works with the capacitor C1 to set the input waveform condition. The resistor R4 and the diode D1 are connected in series between the output of the comparator IC U1-A and the node between the capacitor C1 and the negative input of the comparator IC U1-A, providing a first direction charge/discharge path that helps shape the TRIANGLE-node waveform. The resistor R5 and the diode D2 are also connected in series between the output of the comparator IC U1-A and the node between the capacitor C1 and the negative input of the comparator IC U1-A and provide a second direction current path opposite to the direction of the current path with the resistor R5 and the diode D2, thereby contributing to waveform shaping and timing behavior.

FIG. 3 shows a similar arrangement as FIG. 2, but in FIG. 3, the output of the comparator U1-A is connected to the positive terminal of the comparator U1-B, and the signal TRIANGLE is connected to the negative terminal of the comparator U1-B.

As seen by comparing the synthetic waveforms in FIGS. 4 and 5, the circuit topology in FIG. 2 results in wider peaks and troughs than the circuit topology in FIG. 3. That is, the pulse widths of the positive and the negative pulses of the synthetic waveform in FIG. 4 are wider than the pulse widths of the positive and the negative pulses of the synthetic waveform in FIG. 5. The propagation delay time of the comparators U1-A, U1-B is about 123 ns, for example, as shown in FIGS. 4 and 5. The propagation delay time varies depending on the comparator IC used. The propagation delay of the camparator IC, including an analog comparator IC, will determine the shape of the synthetic waveform (e.g., the pulse widths of the positive and the negative pulses). Because different comparator ICs have different propagation delay times, different comparator ICs will have synthetic waveforms with different shapes. The comparator can be chosen to provide an appropriate propagation delay time that matches a desired switching frequency. As shown in the synthetic waveforms in FIGS. 4 and 5, the intended phase-shifted waveform was accurately produced. The on duty of the synthetic waveform in FIG. 4 is about 80%. To decrease the on-duty, either the frequency of the signal TRIANGLE can be increased or another comparator IC having a different propagation delay can be selected. When the frequency of the signal TRIANGLE increases, the period of the signal TRIANGLE decreases so that the propagation delay (e.g., about 123 ns) of the comparator IC occupies a smaller fraction of one cycle of the signal TRIANGLE. As a result, the pulse width of the synthetic waveform becomes relatively narrow, and the on duty in FIG. 4 can be reduced.

The synthetic waveforms can be used to turn on and off switches. For example, the synthetic waveforms can be used to turn on and off discrete power switches or power switches in an IC. For example, as shown in FIGS. 6, 9, and 13, the synthetic waveforms can be used to turn on and off power switches in the full-bridge power module ICs U2 and U3, and as shown in FIG. 12, the synthetic waveforms can be used to turn on and off the power switches Q1, Q2, Q3, Q4. But it is possible to use the signal generators of FIGS. 2 and 3 in other arrangements. For example, the signal generators of FIGS. 2 and 3 can be used as a pulse-width modulation (PWM) oscillator and can be used with power block circuits or ICs of LLC and zero-voltage switching (ZVS) resonant switching power supply drive circuits. The signal generators of FIGS. 2 and 3 can be used to implement open-loop control of small-capacity DC-DC converters, for example, DC-DC converters having a power range of several watts to about 100 W. The signal generators of FIGS. 2 and 3 can also be applied as a gate drive power source for DC-AC inverters, solar power generation, electric vehicles, etc.

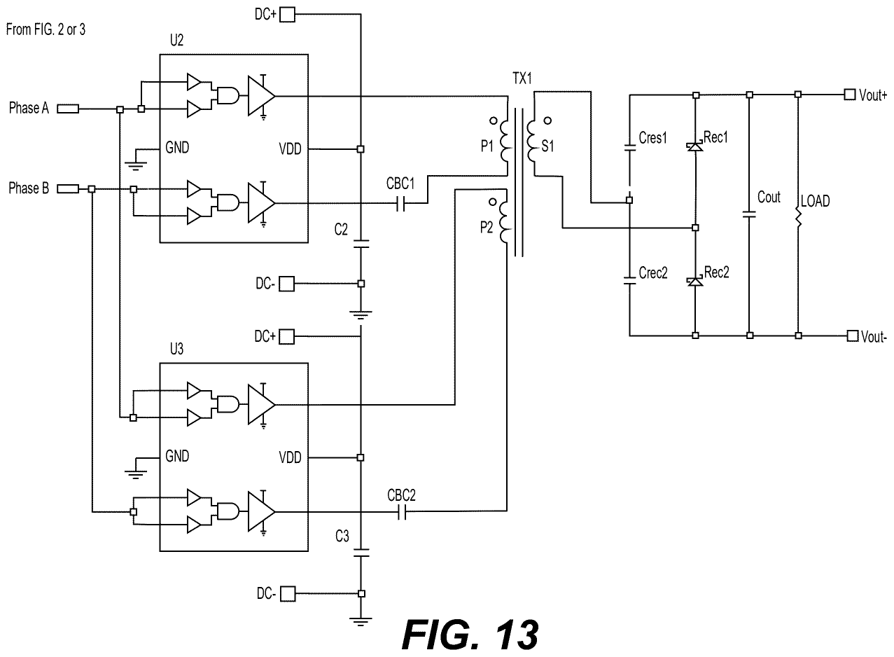

FIGS. 6, 12, and 13 show circuit diagrams of possible converters that can be used with the signal generators of FIGS. 2 and 3. FIG. 6 shows a phase-shift, full-bridge LLC converter. FIG. 12 shows a full bridge converter including two separate half-bridge converters. FIG. 13 shows a two-phase, phase-shift, full-bridge LLC converter. The signal generators of FIGS. 2 and 3 can also be used with other converters.

The converters of FIGS. 6, 12, and 13 include a primary stage connected to the primary winding of the transformer on the left side and include a secondary stage connected to the secondary winding of the transformer on the right side. The primary stages include a switching circuit that controls the current through the primary winding. The primary circuit in FIG. 13 includes two phases with full-bridge power module ICs U2 and U3. The secondary stages of the converters in FIGS. 6, 12, and 13 include a rectifying circuit and an output capacitor Cout. The resistor LOAD in the secondary stages in FIGS. 6, 12, and 13 represents the load on the converters.

In FIG. 6, the primary stage includes a full-bridge power module IC U2, a primary winding P1 of the transformer TX1, and a capacitor CBC. The full-bridge power module IC U2 can be connected to one of the signal generators of FIGS. 2 and 3. The full-bridge power module IC U2 can define a switching circuit and can include power switches arranged in a full bridge arrangement that are switched on and off based on the synthetic waveform received from the signal generator of FIG. 2 or 3. The power switches can be connected to the switching output terminals within the full-bridge power module IC U2. The switching output terminals can be connected to opposite ends of the primary winding P1 of the transformer TX1. It is possible to use several Power ICs, MOSFET Modules, etc., instead of the full-bridge power module IC U2. For example, FIG. 12 shows the use of two half-bridge modules arranged as a phase-shift, full-bridge converter. In FIG. 6, the supply voltage of the full-bridge power module IC U2 is provided by the VDD and GND terminals of the full-bridge power module IC U2. The GND terminal is connected to ground, and the VDD terminal is connected to capacitor C2, which is connected across the terminals DC+, DC−. The capacitor C2 provides the switching current for the power switches included in the full-bridge power module IC U2 at the VDD terminal, which defines an input-switching-current terminal of the full-bridge power module IC U2.

In FIG. 6, the capacitor CBC is connected between the full-bridge power module IC U2 and the transformer TX1 to resonate with the primary leakage inductance of the transformer TX1 and to provide a sinusoidal current to the secondary stage.

The secondary stages can include a rectifier circuit and an output capacitor Cout connected to the rectifier circuit. In FIGS. 6, 12, and 13, the rectifier circuits may be a double-voltage rectifier circuit including capacitors Cres1, Cres2 and diode Rec1, Rec2, and the rectifier circuit resonates with the secondary leakage inductance of the transformer TX1 and capacitors Cres1, Cres2. But any of the converters in FIGS. 6, 12, and 13 can include a different secondary stage, including, for example, a full-wave rectifier circuit that does not include any capacitors, instead of the double-voltage rectifier circuit. The secondary stages can also include an additional secondary winding that provides a second output voltage. Instead of using diodes Rec1, Rec2, it is also possible to use synchronous rectifiers (e.g., MOSFETs) to provide a rectified output voltage.

The turns ratio of the transformer TX1 can be calculated as follows. First, the winding ratio of a conventional full-bridge method and the full-wave rectifier method is shown in Equation 1.

$$NPS\_FULL = \frac{Vin\_typical}{Vout\_typical + ( 4 \times V f ) + Other\_drop \_voltage} \qquad ( 1 )$$

The turns ratio of the phase-shift full-bridge LLC converter must be reflected in the phase difference between the two converters. The calculation formula is shown in Equation 2.

$$NPS\_PSFB \_FULL \_VD = \frac{Vin\_typical \times PSFB\_Shift}{( 0.5 \times Vout\_typical ) + ( 2 \times V f ) + Other\_drop \_voltage} \qquad ( 2 )$$

Vin_typical is the representative input voltage applied to the DC-DC converter and is the nominal input voltage used as the design basis. Vout_typical is the representative output voltage delivered to the load and is the target output voltage used for calculating the turns ratio. Vf is the forward voltage drop of one rectifier diode. In the equations, 2×Vf or 4×Vf reflects the number of conducting diodes. Other_drop_voltage is the sum of other voltage drops in the circuit, such as wiring, switches, and winding resistance and is included to reflect practical circuit losses. PSFB_Shift is the phase-shift related factor affecting the effective output voltage in phase-shift full-bridge operation and is used to reflect the phase-difference effect in the turns-ratio calculation.

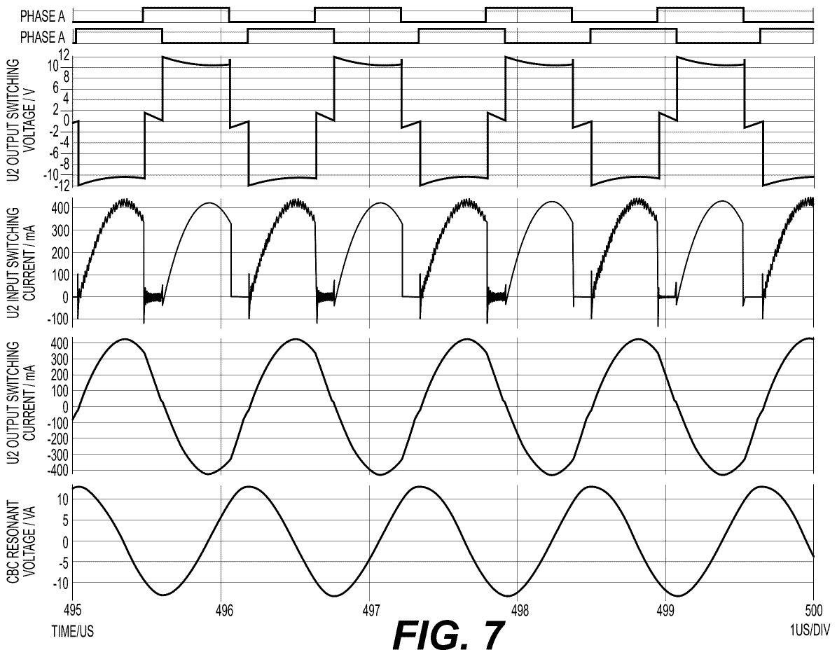

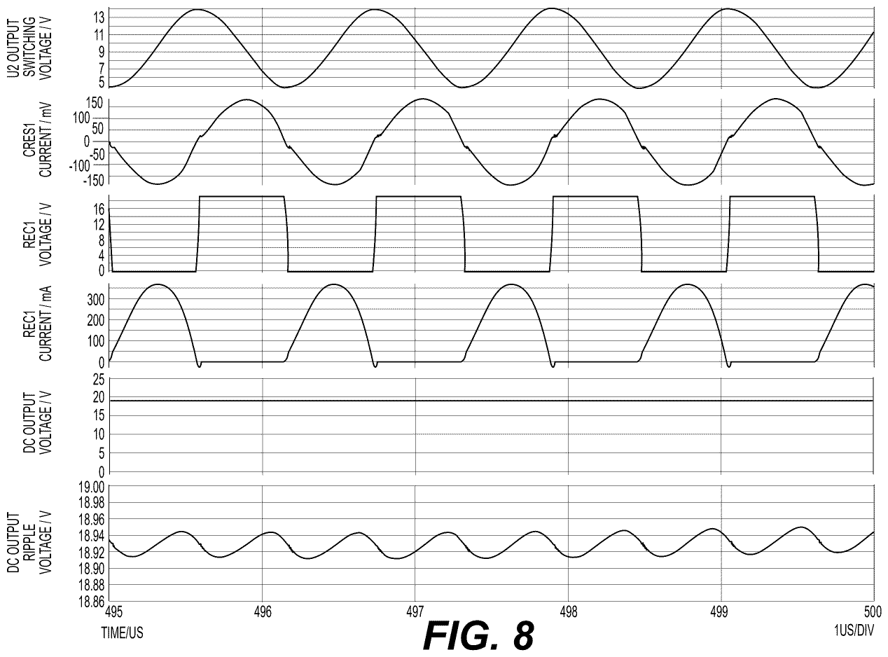

The operating waveforms of the phase-shift, full-bridge LLC converter of FIG. 6 are shown in FIGS. 7 and 8. FIG. 7 shows the first square wave Phase A and the second square wave Phase B that are received from the signal generator of FIG. 2, the output switching voltage of the full-bridge power module IC U2, the input switching current of the full-bridge power module IC U2, the output switching current of the full-bridge power module IC U2, and the resonant voltage across the capacitor CBC. FIG. 8 shows the output switching voltage of the full-bridge power module IC U2, the current through the capacitor Cres1, the voltage across the diode Rec1, the current through the diode Rec1, the output voltage across the terminals Vout+, Vout−, and the DC output ripple current.

The converter in FIG. 12 includes, in the primary stage, two separate half-bridge converters that are connected as a full-bridge converter and that define a switching circuit. The first half-bridge converter including switches Q1, Q2 is connected to the first square wave Phase A, and the second half-bridge converter including switches Q3, Q4 is connected to the second square wave Phase B. The converter in FIG. 12 includes a capacitor CBC connected between the second half-bridge converter including switches Q3, Q4 and the transformer TX1. As with the converter in FIG. 6, the capacitor CBC in the converter in FIG. 12 resonates with the primary leakage inductance of transformer TX1 and provides a sinusoidal current to the secondary stage. As explained above, the secondary stage in FIG. 12 is similar to the secondary stage in FIG. 6.

The converter in FIG. 13 includes, in the primary stage, first and second phases with full-bridge power module ICs U2 and U3 that define a switching circuit. The first phase includes the full-bridge power module IC U2, a primary winding P1 of the transformer TX1, and a capacitor CBC1, and the second phase includes the full-bridge power module IC U3, a primary winding P2 of the transformer TX1, and a capacitor CBC2. The full-bridge power module ICs U2, U3 can be connected to one of the signal generators of FIGS. 2 and 3. The full-bridge power module ICs U2, U3 can include power switches arranged in a full bridge arrangement that are switched on and off based on the synthetic waveform received from the signal generator of FIG. 2 or 3. As shown in FIG. 13, the first square wave Phase A from the signal generator in FIG. 2 or 3 can be provided to both of the full-bridge power module ICs U2, U3, and the second square wave Phase B from the signal generator in FIG. 2 or 3 can be provided to both of the full-bridge power module ICs U2, U3. In FIG. 13, the supply voltages of the full-bridge power module ICs U2, U3 are provided by their respective VDD and GND terminals. The GND terminals are connected to ground. The VDD terminal of the full-bridge power module IC U2 is connected to the capacitor C2, which is connected across the terminals DC+, DC−, and the VDD terminal of the full-bridge power module IC U3 is connected to the capacitor C3, which is connected across the terminals DC+, DC−. The VDD terminals of the full-bridge power module ICs U2, U3 can define input-switching-current terminals. The capacitors C2, C3 provide the switching current for the power switches included in the full-bridge power module ICs U2, U3. As explained above, the secondary stage in FIG. 13 is similar to the secondary stages in FIGS. 6 and 12.

In FIG. 13, the capacitor CBC1 is connected between the full-bridge power module IC U2 and the primary winding P1 of the transformer TX1 to resonate with the primary leakage inductance of transformer TX1 and to provide a sinusoidal current to the secondary stage, and the capacitor CBC2 is connected between the full-bridge power module IC U3 and the primary winding P2 of the transformer TX1 to resonate with the primary leakage inductance of transformer TX1 and to provide a sinusoidal current to the secondary stage.

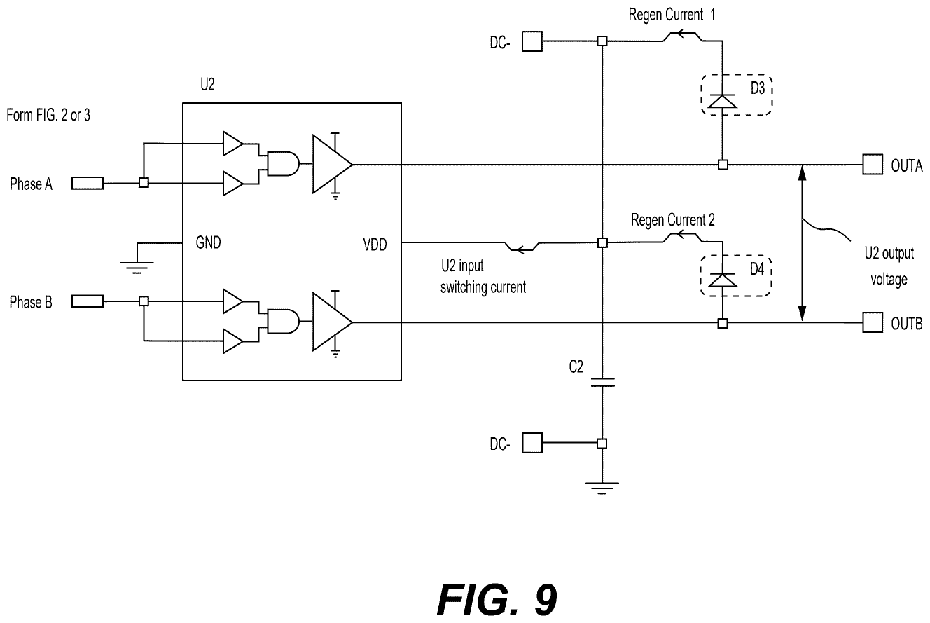

When a power module IC is used as the full-bridge power module IC U2, the conversion efficiency of the phase-shift, full-bridge LLC converter can be slightly low due to the characteristics of the power switches (e.g., MOSFETs) within the power module IC. Adding one or more regenerative circuits to a converter can improve conversion efficiency. The regenerative circuit can be connected to the first and the second switching output terminals and the VDD terminal (i.e., the input-switching-current terminal) of the full-bridge power module IC U2. For example, adding diodes D3, D4 to the switching output terminals of the power module IC of a phase-shift, full-bridge LLC converter as shown in FIG. 9 creates a regenerative circuit (e.g., a regenerative loop), which can improve the conversion efficiency of the converter. The diodes D3, D4 can be, for example, Schottky barrier diodes (SBDs). Another regenerative circuit (e.g., diodes or SBDs) can be connected between the output terminal of the power module ICs and ground.

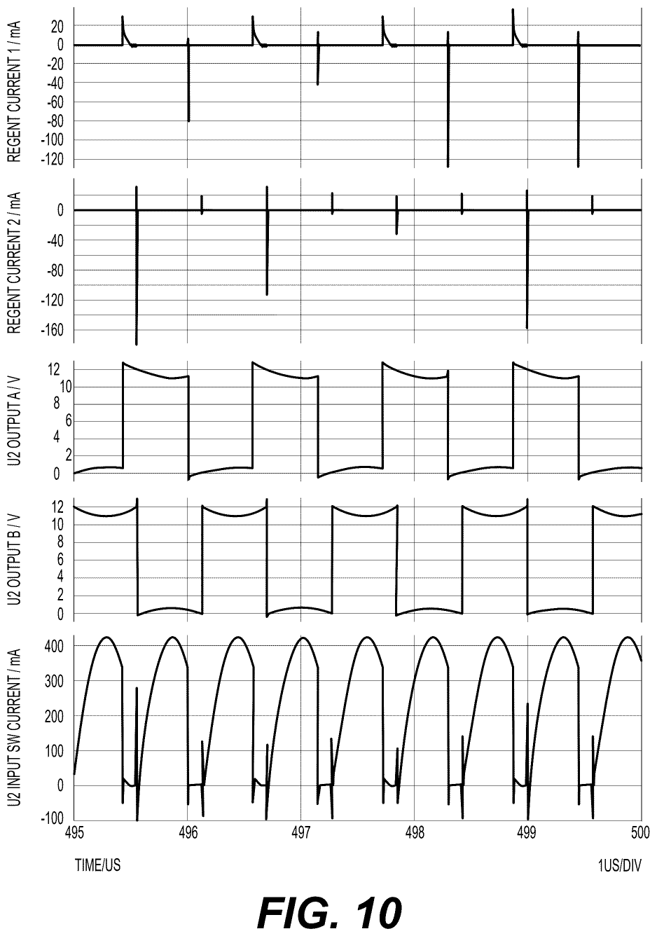

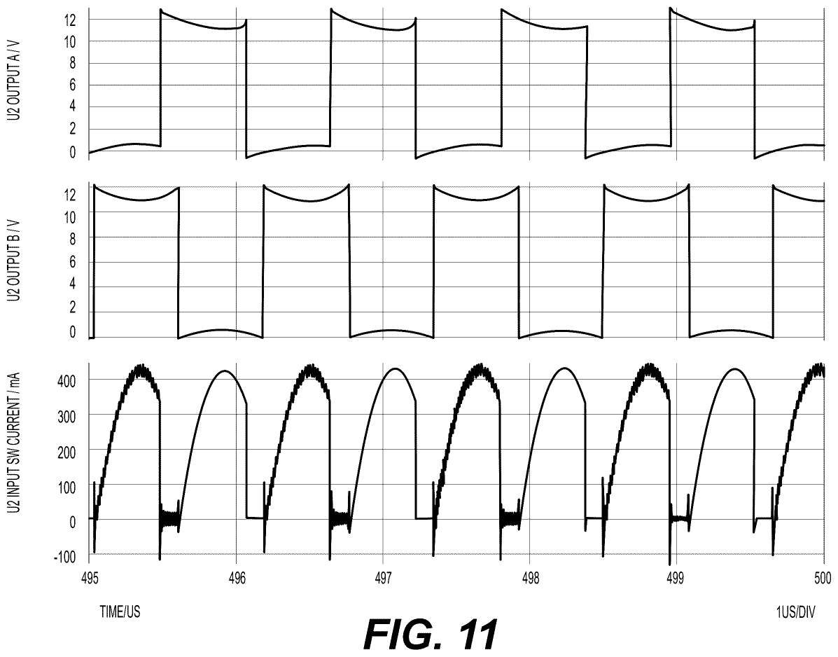

The conversion efficiency can be improved by about 5% or more, within manufacturing and/or measurement tolerances, for example, by the regenerative circuit including the diodes D3, D4 and indicated by the rectangles with dotted lines in FIG. 9. The power switches of the full-bridge power module IC U2 can be connected to the switching output terminals OUTA, OUTB of the full-bridge power module IC U2 that are connected to the primary winding P1 of the transformer TX1 of FIG. 6. In FIG. 9, the switching output terminals OUTA, OUTB are connected to opposite ends of the primary winding P1 (the primary winding P1 is not shown in FIG. 9 but is shown in FIG. 6). FIG. 10 shows waveforms when a regenerative circuit is used, and FIG. 11 shows waveforms when a regenerative circuit is not used. FIG. 10 shows the regenerative current Regen Current 1 through diode D3, the regenerative current Regen Current 2 through diode D4, the output voltage of the top switching output terminal OUTA, the output voltage of the bottom switching output terminal OUTB, and the input switching current of the full-bridge power module IC U2. FIG. 11 shows the output voltage of the top switching output terminal OUTA, the output voltage of the bottom switching output terminal OUTB, and the input switching current of the full-bridge power module IC U2. Comparing FIG. 10 with FIG. 11 shows the different shapes of the input switching currents of the full-bridge power module IC U2 when using the regenerative circuit and when not including the regenerative circuit. The input switching current of the full-bridge power module IC U2 using the regenerative circuit is reduced by about 5%, within manufacturing and/or measurement tolerances, for example, compared to not using the regenerative circuit. A regenerative circuit can also be applied to the two-phase converter shown in FIG. 13. For example, a first regenerative circuit can be connected to the switching output terminals of the full-bridge power module IC U2, and/or a second regenerative circuit can be connected to the switching output terminals of the full-bridge power module IC U3.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A full-bridge LLC converter comprising:
a transformer including a primary winding and a secondary winding; and
a primary stage connected to the primary winding and including:
a power module integrated circuit (IC) including:
a first switching output terminal connected to a first end of the primary winding;
a second switching output terminal connected to a second end of the primary winding opposite to the first end of the primary winding;
power switches connected to the first and the second switching output terminals within the power module IC; and
an input-switching-current terminal that receives an input switching current that is provided to the power switches; and
a regenerative circuit that is connected to the first and the second switching output terminals and the input-switching-current terminal to provide a regenerative current to the power switches.

2. The full-bridge LLC converter of claim 1, wherein the regenerative circuit includes:
a first diode connected between the first switching output terminal and the input-switching-current terminal; and
a second diode connected between the second switching output terminal and the input-switching-current terminal.

3. The full-bridge LLC converter of claim 2, wherein
the first diode includes a first Schottky barrier diode; and/or
the second diode includes a second Schottky barrier diode.

4. The full-bridge LLC converter of claim 1, further comprising:
an additional power module integrated circuit (IC) that is in the primary stage and that includes additional power switches; and
an additional regenerative circuit that is connected to the additional power module IC and that provides an additional regenerative current to the additional power switches.

5. The full-bridge LLC converter of claim 1, further comprising a secondary stage that is connected to the secondary winding and that includes a voltage-doubling rectifier circuit.

6. A signal generator comprising:
a first comparator integrated circuit (IC) that provides a first square wave; and
a second comparator integrated circuit (IC) that receives the first square wave at an input terminal of the second comparator IC and that provides a second square wave that is phase shifted with respect to the first square wave by a propagation delay time of the second comparator IC.

7. The signal generator of claim 6, wherein the input terminal is a positive terminal of the second comparator IC.

8. The signal generator of claim 6, wherein the input terminal is a negative terminal of the second comparator IC.

9. The signal generator of claim 6, wherein the first and/or the second comparator IC includes an analog comparator IC.

10. The signal generator of claim 6, wherein the first and/or the second comparator IC includes a high-speed analog comparator IC.

11. A converter comprising:
the signal generator of claim 6;
a transformer including a primary winding and a secondary winding; and
a primary stage including a switching circuit that includes power switches connected to the primary winding, that receives the first and the second square waves from the signal generator, and that turns on and off the power switches based on the first and the second square waves to control current in the primary winding.

12. The converter of claim 11, wherein the switching circuit includes a full-bridge power module integrated circuit (IC) that includes the power switches.

13. The converter of claim 12, further comprising a regenerative circuit that is connected to the full-bridge power module IC and that provides a regenerative current to the power switches.

14. The converter of claim 13, wherein
the full-bridge power module IC includes:
a first switching output terminal connected to a first end of the primary winding;
a second switching output terminal connected to a second end of the primary winding opposite to the first end of the primary winding; and
an input-switching-current terminal that receives an input switching current that is provided to the power switches;
the power switches are connected to the first and the second switching output terminals within the full-bridge power module IC; and
the regenerative circuit is connected to the first and the second switching output terminals and the input-switching-current terminal to provide the regenerative current to the power switches.

15. The converter of claim 12, wherein the switching circuit includes an additional full-bridge power module integrated circuit (IC).

16. The converter of claim 11, wherein the switching circuit includes two separate half-bridge converters that are connected to define a full-bridge converter.

17. The converter of claim 11, further comprising a secondary stage that is connected to the secondary winding and that includes a voltage-doubling rectifier circuit.
